(19) United States
(12) Patent Application Publication
(10) Pub. No.: US 2012/0255434 A1
(43) Pub. Date: Oct. 11, 2012

(54) Piston

(75) Inventor: Sam Cockerill, Yorkshire (GB)

(73) Assignee: LIBERTINE FPE LTD., Yorkshire (UK)

(21) Appl. No.: 13/517,155

(22) PCT Filed: Dec. 17, 2010
(86) PCT No.: PCT/GB2010/052121

§ 371 Date: Jun. 19, 2012

(30) Foreign Application Priority Data
Dec. 24, 2009 (GB) 0922541.8

(51) Int. Cl. F16J 1/00; F16J 9/12

(52) U.S. Cl. 92/248; 92/172

(57) ABSTRACT

A piston for an engine generator, comprising alternating laminated core elements and non-magnetising spacer elements arranged along a piston shaft and secured such that contact is maintained between neighbouring elements, wherein the length of the piston is at least at least five times its maximum diameter.

The present invention relates to a piston and in particular a piston for an engine generator.

In standard combustion engines, pistons are mechanically restrained within their cylinder as a result of being connected to a crankshaft, which is driven rotationally as a result of the reciprocal linear movement of the piston within the cylinder. In a free piston engine, however, the piston is not connected to a crankshaft, although pistons may be provided within an engine of this type that do have external mechanical linkages such as taught in U.S. Pat. No. 7,383,796.

Furthermore, it is known that electrical power can be generated by movement of a reciprocating piston in a free piston engine through one or more electrical coils to generate a magnetic flux change, for example U.S. Pat. No. 7,318,506. In this arrangement the piston carries a first coil and as it reciprocates within the cylinder it generates an electric current in a second coil that surrounds the cylinder. However, the piston is constructed from a solid piece of material that is permeable to magnetic flux and is necessarily very short relative to the length of the cylinder so that it may induce the flux changes as it passes through the second coil.

In existing free piston engines, the length of the piston is typically less than at least five times the diameter of the cylinder bore of the combustion chamber. The power output of the electrical machine in a free piston engine is determined by the area of the air gap, and to achieve an air gap area sufficient for a given combustion chamber geometry, which is determined by the diameter and swept volume, the diameter of the electrical machine is generally larger than the diameter of the combustion chamber. This change in diameter necessitates complex and expensive mechanical solutions to seal each combustion chamber, and to ensure that these are coaxially aligned with each other and with the axis of the intervening electrical machine.

According to the present invention there is provided a piston for an engine generator, comprising alternating laminated core elements and non-magnetising spacer elements arranged along a piston shaft and secured such that contact is maintained between neighbouring elements, wherein the length of the piston is at least five times its maximum diameter.

This arrangement provides a better match between the power output of the combustion chamber and the power capacity of the air gap having an area equal to the cylindrical surface of the elongated piston. As a result, the air gap and combustion chamber diameters can be equivalent and no change in diameter is required between the combustion chambers at opposite ends of the piston. As a result, this piston enables a free piston engine to be constructed at lower cost than existing types of free piston engine.

Furthermore, the present invention provides a piston that is particularly effective in an engine generator having a plurality of coils spaced along a cylinder in which the piston reciprocates due to the alternating nature of the laminated core and spacer elements. The core elements are laminated to reduce eddy currents.

Preferably, a piston crown is provided at each extremity of the piston to protect the core and spacer elements from the effects of combustion. Preferably, the piston crown is constructed from a temperature resistant and insulating material such as ceramic, and/or has a concave surface to reduce heat loss at top dead centre.

Preferably, one or more bearing rings are spaced along the piston shaft for bearing the weight of the piston, and any other side loads present, whilst keeping frictional losses and wear to a minimum and hence avoid warping piston seizure. Preferably, the one or more bearing rings is constructed from a hard, wear-resistant material such as ceramic or carbon.

Preferably the diameter of the one or more bearing rings is greater than the diameter of the core and spacing elements to ensure that only the bearing rings are in contact with the cylinder to reduce friction during movement of the piston.

Preferably, the core elements and spacer elements are formed as annular rings having the same diameters.

Preferably, the spacer elements are constructed from a lightweight material such as aluminium alloy to achieve a low total piston mass and thereby reduce mechanical forces exerted on a machine having the piston. Preferably, the spacer elements have voids formed within them to further reduce their weight.

Preferably, the piston crown incorporates oil control features to reduce engine wear and limit hydrocarbon emissions by ensuring a consistent thickness of oil film on the cylinder wall following each stroke.

Preferably, the piston crown incorporates sealing ring features to reduce the extent of blow-by gases escaping from the combustion chamber along the gap between the outside of the piston and the inside wall of the cylinder

An example of the present invention will now be described with reference to the following figure, in which:

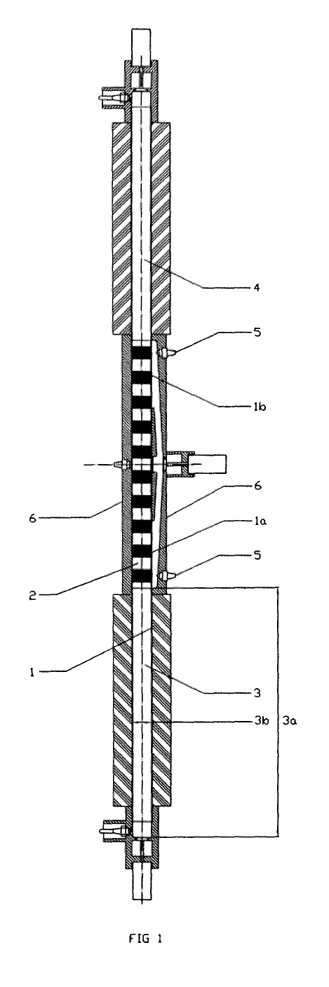

FIG. 1 shows a longitudinal section through a cylinder having a piston according to an example of the present invention;

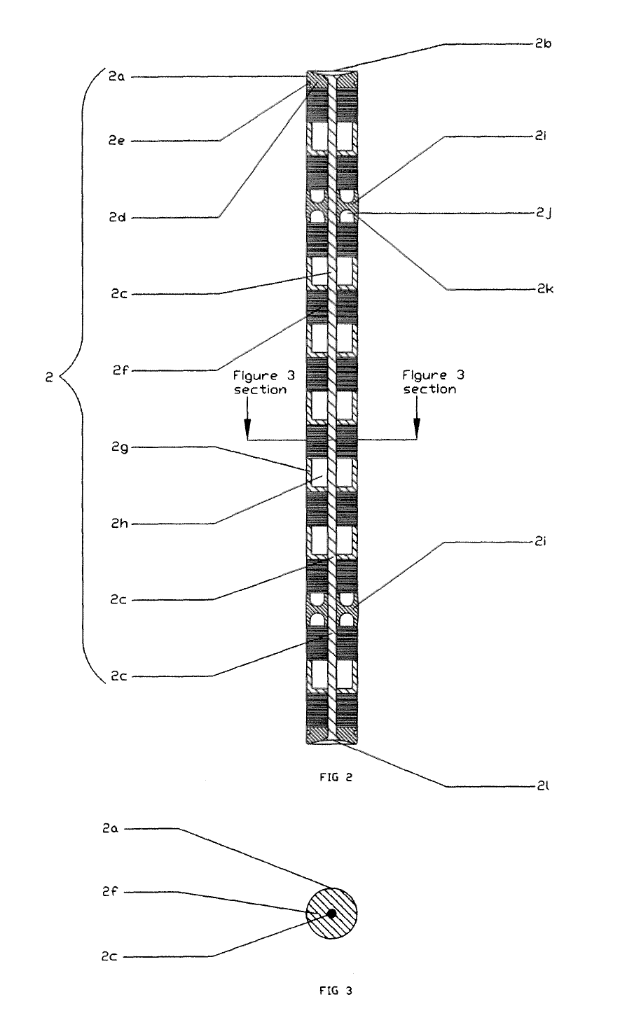

FIG. 2 is a longitudinal section through the piston, showing the construction from planar elements;

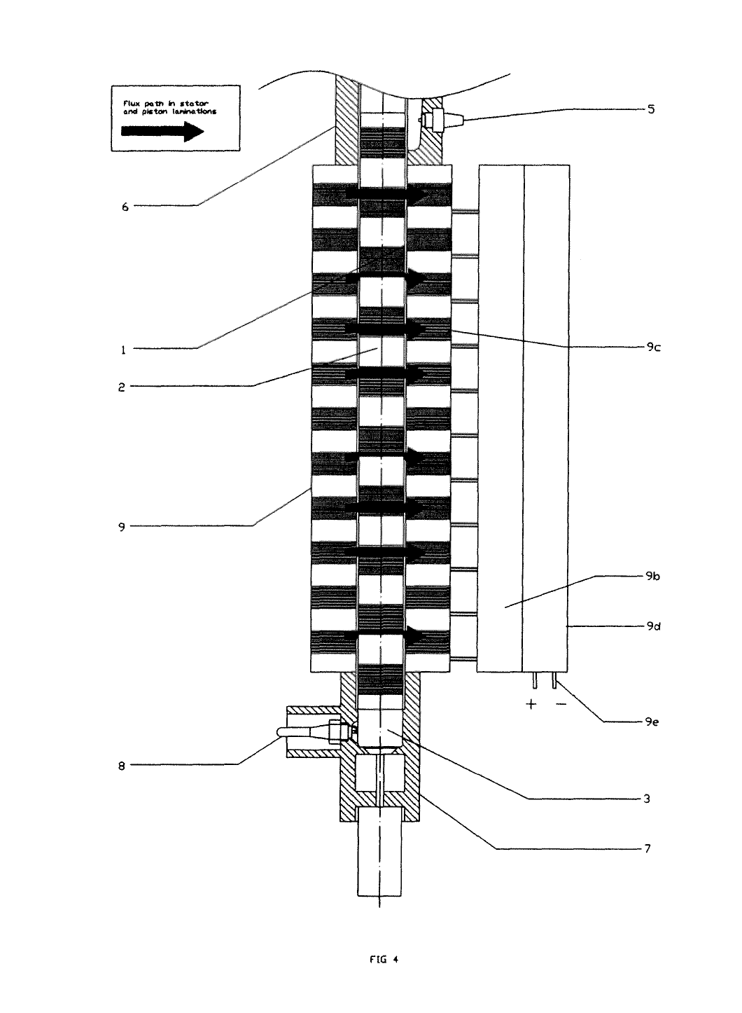

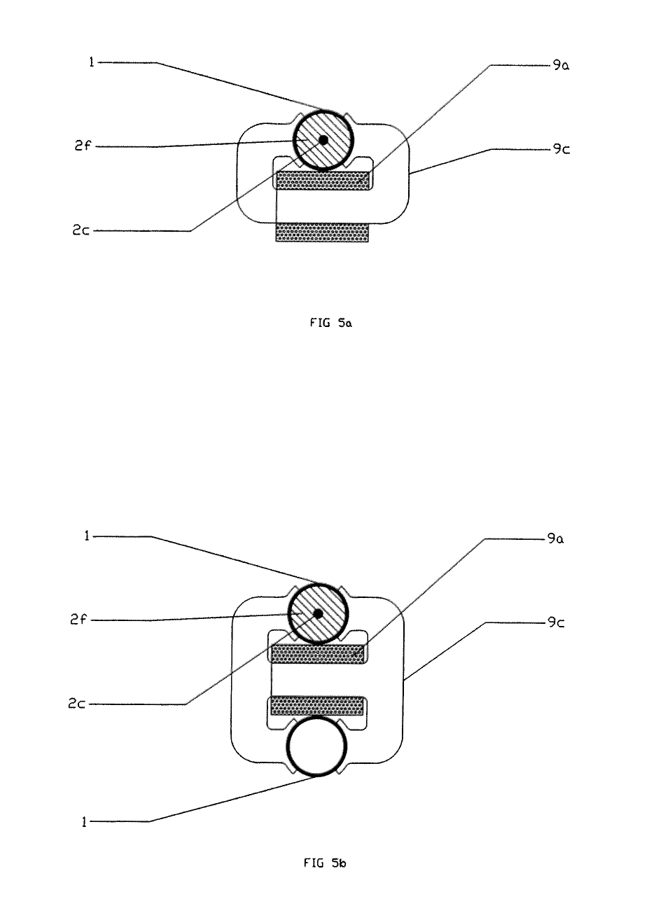

FIG. 3 is a perpendicular section through the piston, showing the concentric arrangement of the shaft and planar elements;

FIG. 4 is a sectional view of the cylinder of FIG. 3 illustrating the magnetic flux in switched stator elements caused by movement of the piston according to the present invention;

FIG. 5a is a perpendicular section through a cylinder showing the linear generator stator and the magnetic circuit formed by a permeable element in the first piston;

FIG. 5b is a perpendicular section of an alternative linear generator stator arrangement for two adjacent cylinders wherein the linear generator stator and the magnetic circuit are formed by a permeable element in the first piston;

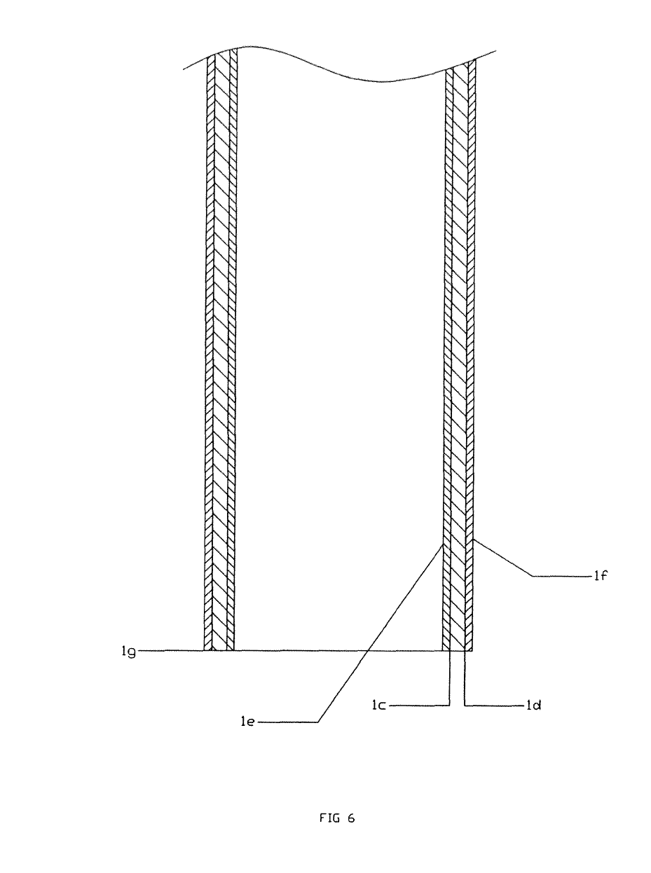

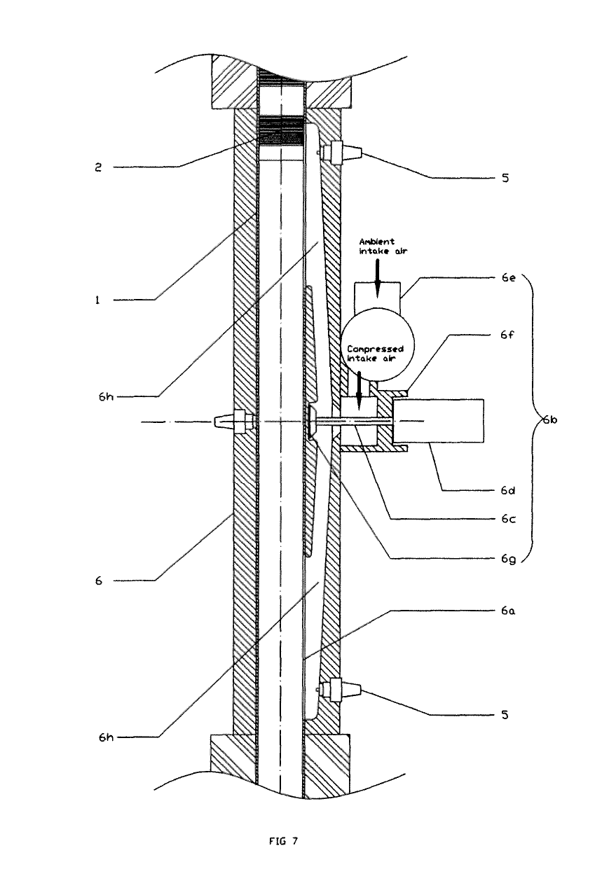

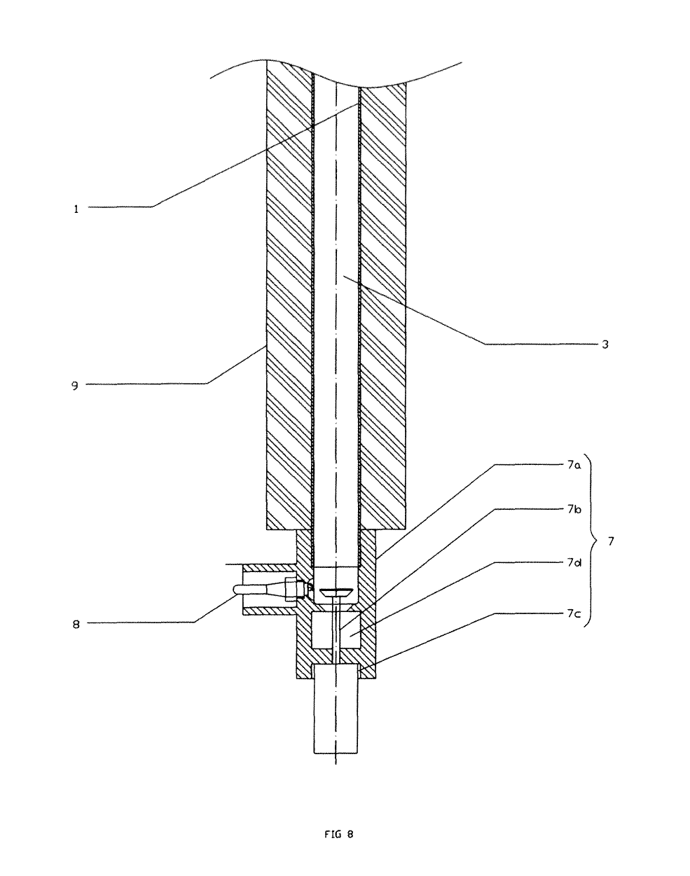

FIG. 6 is a partial sectional view of the cylinder illustrating its construction;

FIG. 7 is a more detailed longitudinal section of the intake poppet valve, intake port valve and fuel injector arrangement during the intake charge displacement scavenging phase;

FIG. 8 is a more detailed longitudinal section of the exhaust means including the exhaust poppet valve and actuator during the exhaust phase;

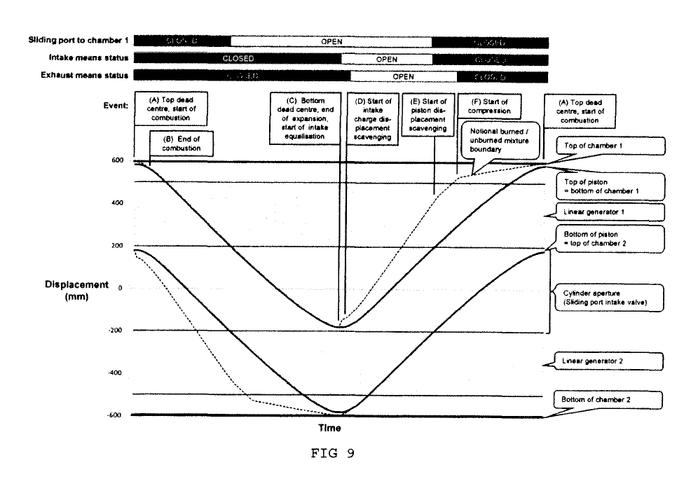

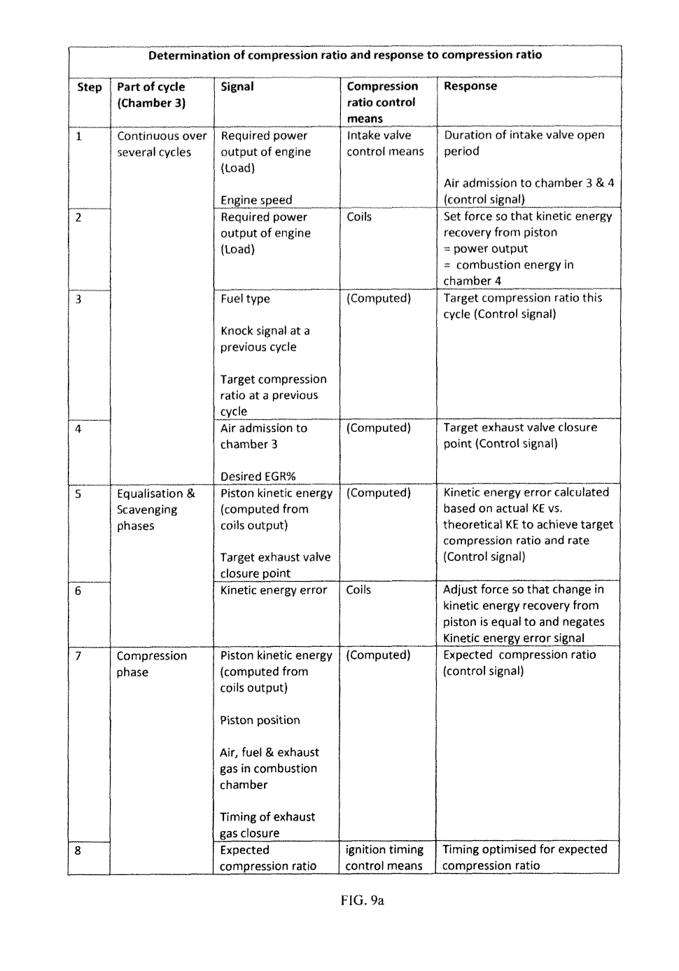

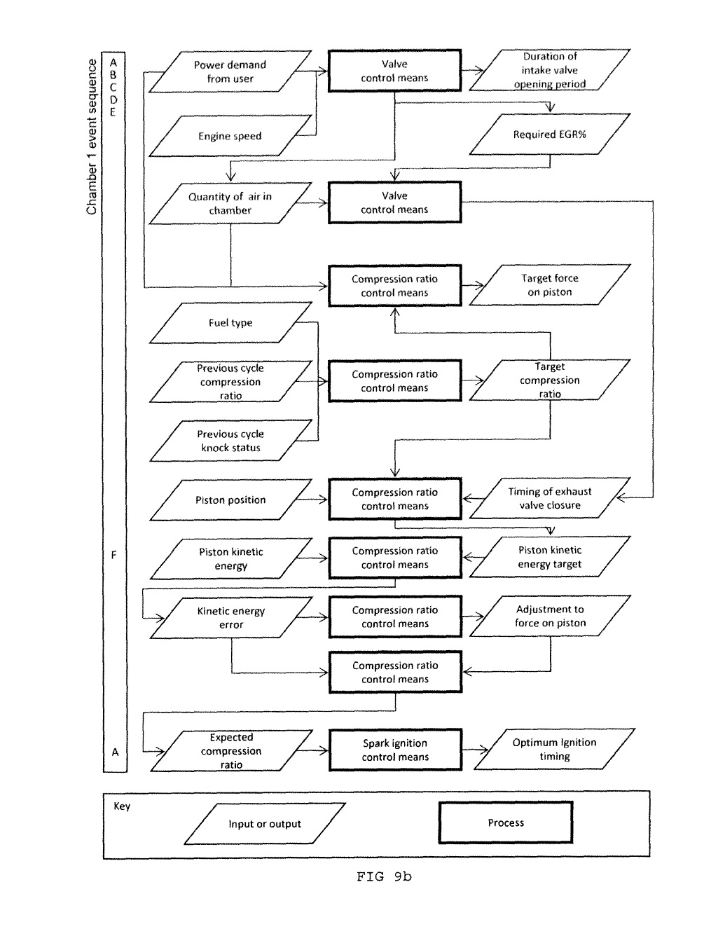

FIG. 9 is a time-displacement plot showing the changing piston position within a cylinder during a complete engine cycle, and the timing of engine cycle events during this period;

FIG. 9a is a table showing different compression ratio control means that may be employed to control the compression ratio in a typical engine cycle;

FIG. 9b is a flow chart showing an exemplary compression ratio control sequence;

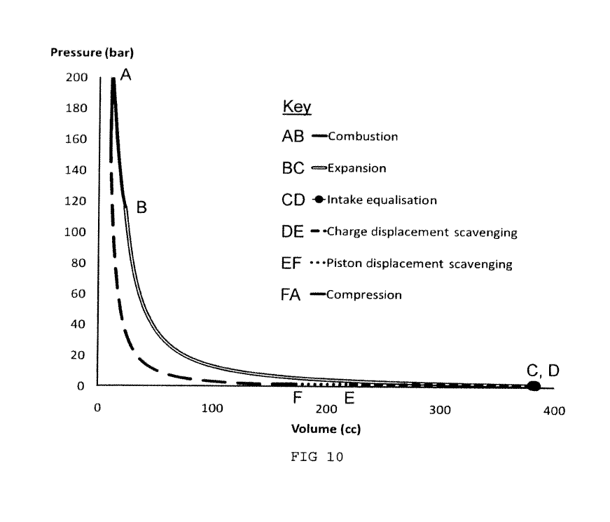

FIG. 10 is a pressure-volume plot showing a typical cylinder pressure plot during a complete engine cycle;

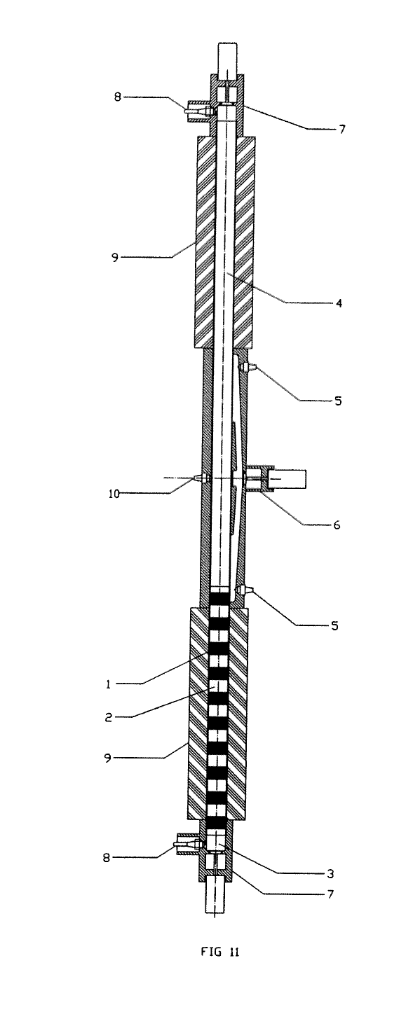

FIG. 11 is a schematic longitudinal section through a cylinder at top dead centre, at the end of the compression phase and around the time of spark ignition and initiation of the combustion event in the first chamber;

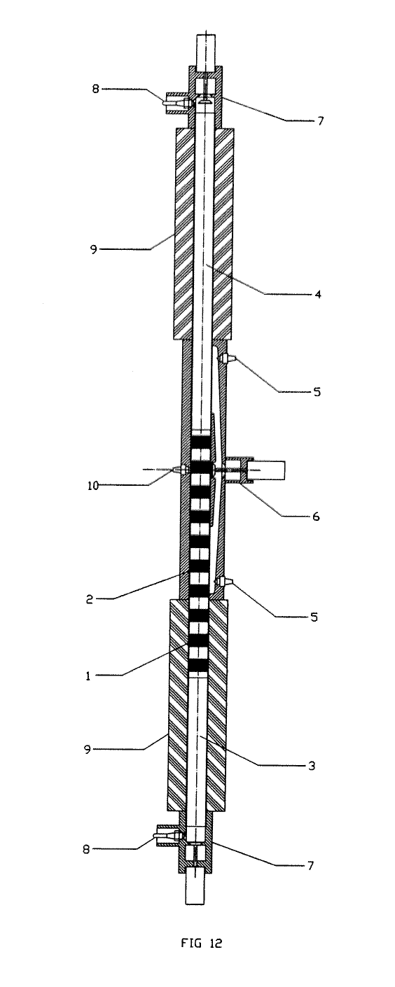

FIG. 12 is a schematic longitudinal section through a cylinder mid way through the expansion phase of the first chamber;

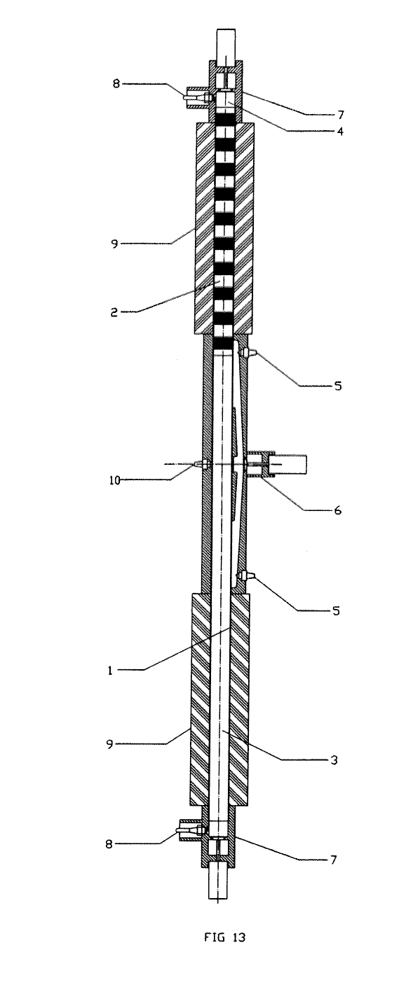

FIG. 13 is a schematic longitudinal section through a cylinder at the end of the expansion phase, but before the intake poppet valve has opened;

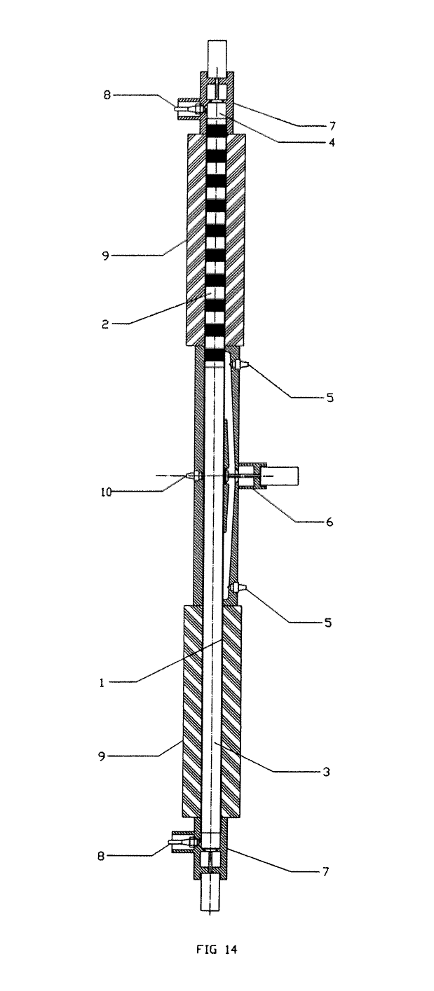

FIG. 14 is a schematic longitudinal section through a cylinder following the opening of the intake poppet valve to charge chamber 1, allowing intake charge fluid pressure to equalise the lower cylinder pressure in the first chamber;

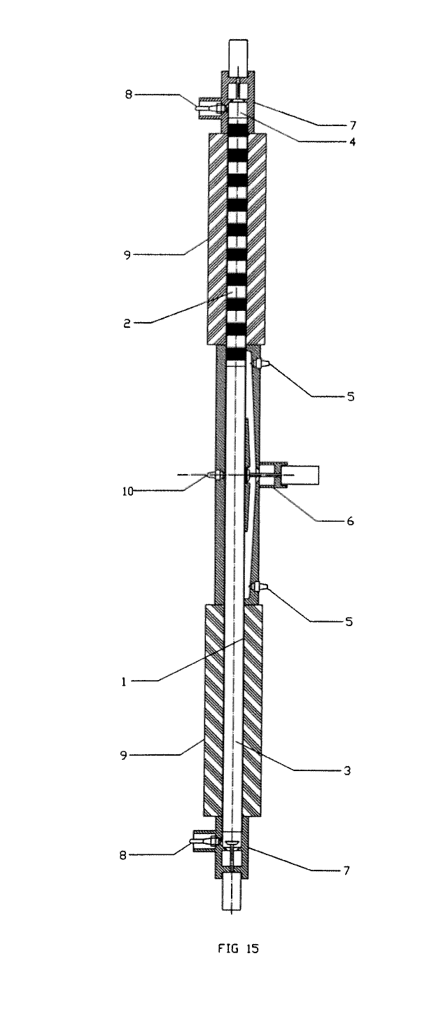

FIG. 15 is a schematic longitudinal section through a cylinder following the opening of the exhaust poppet valve, and whilst the intake poppet valve remains open, scavenging the first chamber;

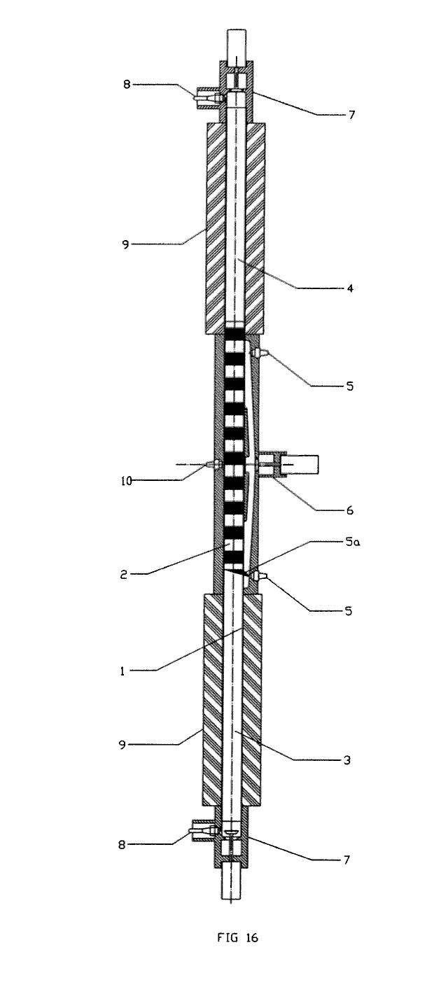

FIG. 16 is a schematic longitudinal section through a cylinder during fuel injection into the first chamber after the intake poppet valve has closed;

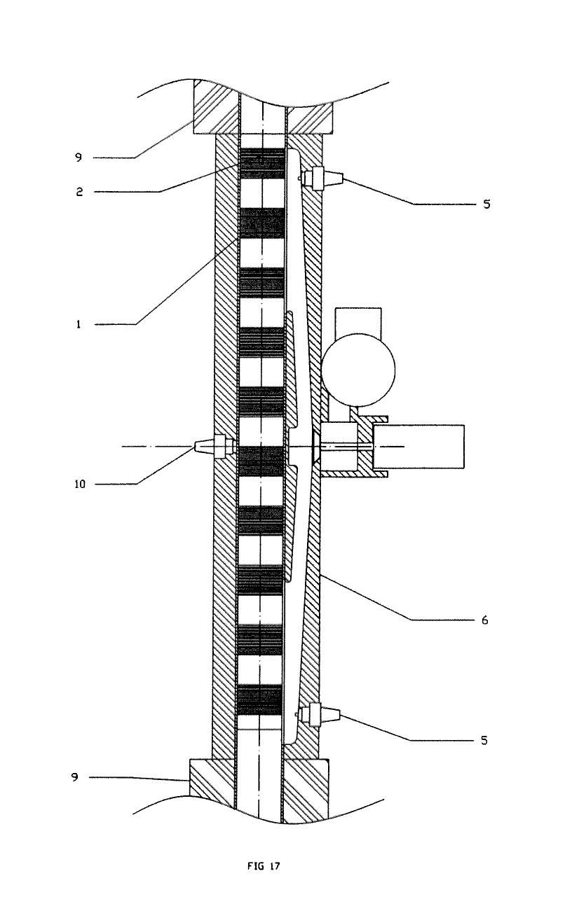

FIG. 17 is a schematic longitudinal section through a cylinder during lubricant injection onto the piston outer surface;

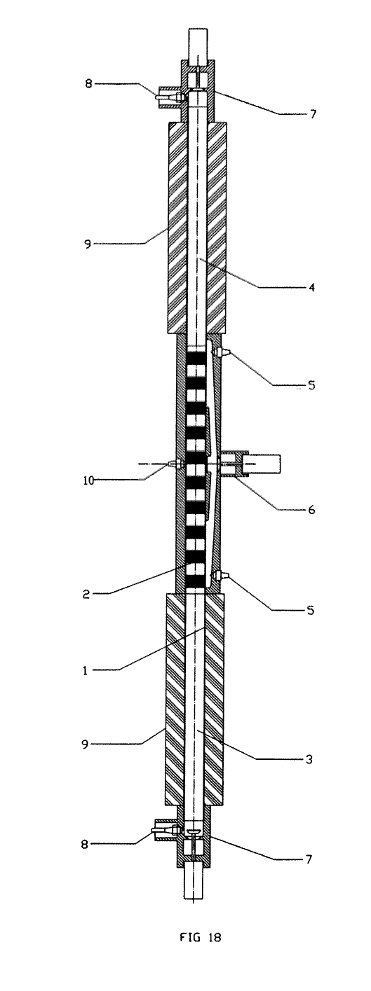

FIG. 18 is a schematic longitudinal section through a cylinder whilst the exhaust poppet valve is open, and after the intake poppet valve and sliding port valve have closed such that continuing expulsion of exhaust gases from the first chamber is achieved by piston displacement;

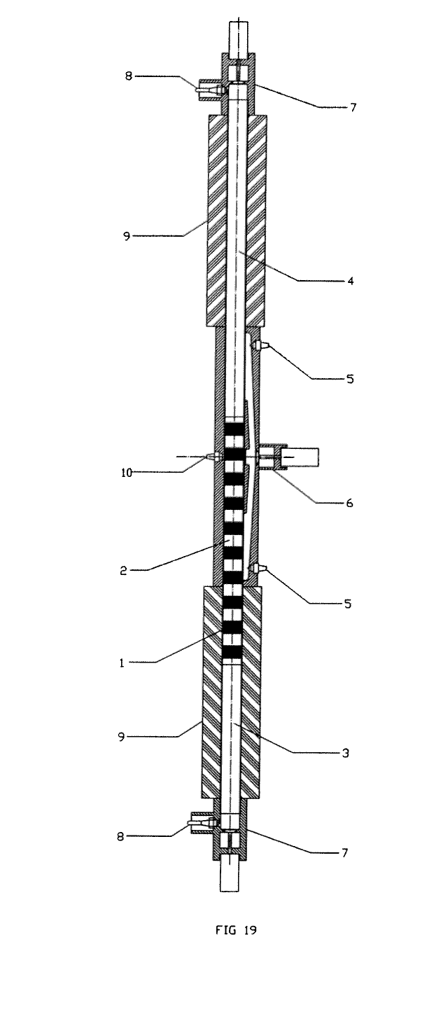

FIG. 19 is a schematic longitudinal section through a cylinder mid way through the compression phase in the first chamber;

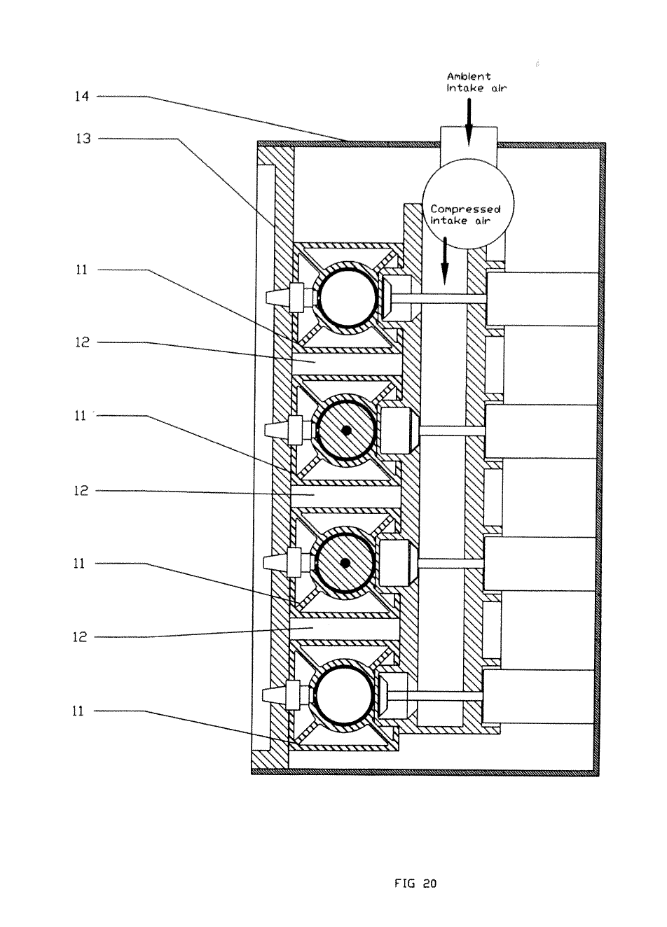

FIG. 20 is a schematic perpendicular section through a four cylinder engine construction through the intake means including the electrical charge compressor;

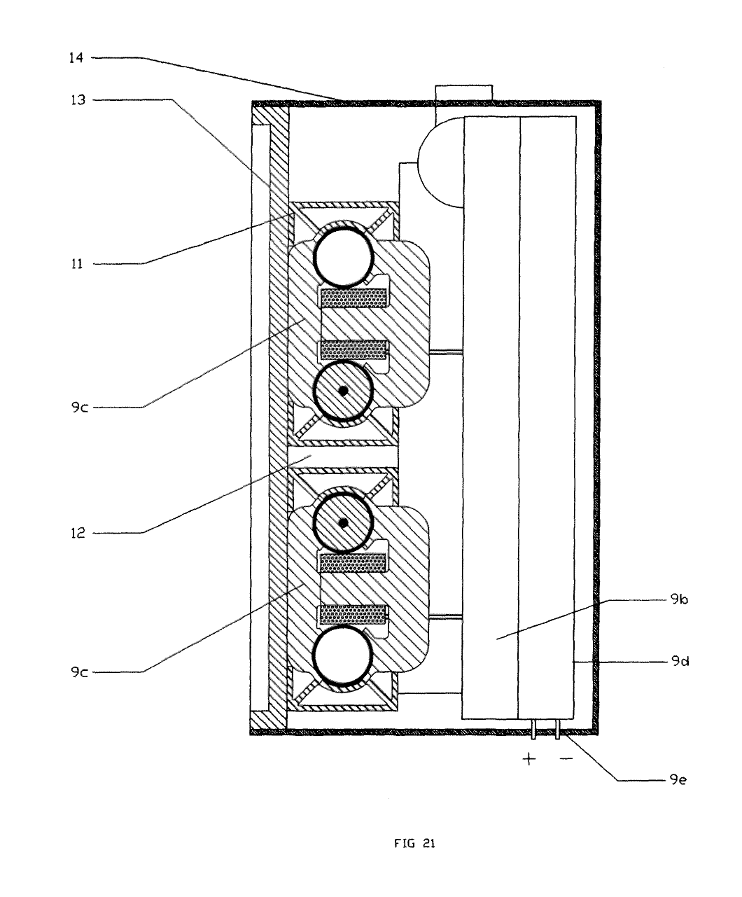

FIG. 21 is a schematic perpendicular section through a four cylinder engine construction through the electrical generator means; and

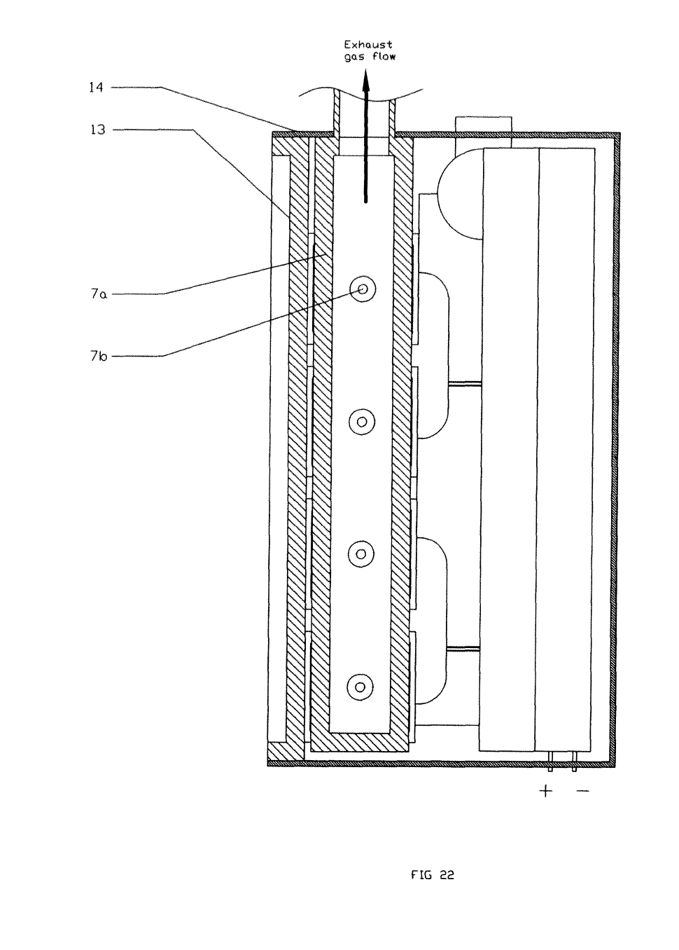

FIG. 22 is a schematic perpendicular section through a four cylinder engine construction through the exhaust means.

FIG. 1 shows an example of the present invention provided within a cylinder of a free piston engine electrical power generation system. It can be seen that the piston 2 is free to move along the length of the cylinder 1, the piston being constrained in coaxial alignment with the cylinder 1, thereby effectively partitioning the cylinder 1 into a first combustion chamber 3 and a second combustion chamber 4, each chamber having a variable volume depending on the position of the piston 2 within the cylinder 1. No part of the piston 2 extends outside the cylinder 1. Using the first chamber 3 as an example, each of the chambers 3, 4 has a variable height 3a and a fixed diameter 3b.

The cylinder 1 is, preferably, rotationally symmetric about its axis and is symmetrical about a central plane perpendicular to its axis. Although other geometric shapes could potentially be used to perform the invention, for example having square or rectangular section pistons, the arrangement having circular section pistons is preferred. The cylinder 1 has a series of apertures la, 1 b provided along its length and distal from the ends, preferably in a central location. Through motion of the piston 2, the apertures 1a, 1b form a sliding port intake valve 6a, which is arranged to operate in conjunction with an air intake 6b provided around at least a portion of the cylinder 1, as is described in detail below.

FIG. 2 shows a piston 2 having an outer surface 2a and comprising a central shaft 2c onto which are mounted a series of cylindrical elements. These cylindrical elements may include a piston crown 2d at each end of the central shaft 2c, each piston crown 2d preferably constructed from a temperature resistant and insulating material such as ceramic. The piston crown end surface 2b is, preferably, slightly concave, reducing the surface area-to-volume ratios of the first and second chambers 3, 4 at top dead centre and thereby reducing heat losses. Of course, if the cylinder was of a different geometry then the configuration of these elements would be adapted accordingly.

The piston crown 2d may include oil control features 2e to control the degree of lubrication wetting of the cylinder 1 during operation of the engine. These oil control features may comprise a groove and an oil control ring as are commonly employed in conventional internal combustion engines.

Laminated core elements 2f are also mounted on the piston shaft 2c. Each core element 2f is constructed from laminations of a magnetically permeable material, such as iron ferrite, to reduce eddy current losses during operation of the engine.

Spacer elements 2g are also mounted on the piston shaft 2c. Each spacer element 2g ideally has low magnetic permeability and is preferably constructed from a lightweight material such as aluminium alloy and has a void 2h formed within it to further reduce its weight and hence reduce mechanical forces exerted on the engine utilising it. The spacer elements 2g are included to fix the relative position of each of the core elements 2f and also act to limit the loss of “blow-by” gases flowing out of each chamber 3, 4 through the gap between the piston wall and cylinder wall, whilst keeping the overall mass of the piston 2 assembly to a minimum.

Bearing elements 2i are also mounted on the piston shaft 2c, located at approximately 25% and 75% of the length of the piston 2 to reduce the risk of thermally-induced distortion of the axis of the piston 2 causing it to lock in the cylinder 1 or otherwise damage the cylinder 1. Each bearing element 2i features a weight-reduction void 2j and has a diameter very slightly larger than the core elements 2f and the spacer elements 2g. The bearing elements 2i also have a profiled outer surface 2k for bearing the weight of the piston 2, and any other side loads present, whilst keeping frictional losses and wear to a minimum. The bearing element 2i are preferably constructed from a hard, wear resistant material such as ceramic or carbon and the profiled outer surface 2k may be coated in a low friction material.

The bearing element 2i may also include oil control features to control the degree of lubrication wetting of the cylinder 1 during operation of the engine. These features may comprise a groove and an oil control ring as are commonly employed in conventional internal combustion engines.

The total length of the piston is, preferably, at least five times its diameter and in any case it is at least sufficiently long to completely close the sliding port valve such that at no time does the sliding port valve allow combustion chambers 3 and 4 to communicate.

FIG. 3 is a sectional view of the piston 2, showing the piston shaft 2c passing through a core element 2f. The piston shaft ends 21 are mechanically deformed or otherwise fixed to the piston crowns 2d such that the elements 2f, 2g, 2i that are mounted to the piston shaft 2c are securely retained under the action of tension maintained in the piston shaft 2c.

The alternating arrangement of core elements 2f and spacers 2g positions the core laminations 2f at the correct pitch for efficient operation as, for example, part of a linear switched reluctance generator machine comprising the moving piston 2 and a linear generator means, for example a plurality of coils spaced along the length of the cylinder within which the piston reciprocates.

FIG. 4 shows an example of linear generator means 9 provided around the outside of the cylinder 1, along at least a portion of its length, for facilitating the transfer of energy between the piston 2 and electrical output means 9e. The linear generator means 9 includes a number of coils 9a and a number of stators 9c, alternating along the length of the linear generator means 9.

The linear generator means 9 may be of a number of different electrical machine types, for example a linear switched reluctance generator. In the arrangement shown, coils 9a are switched by switching device 9b so as to induce magnetic fields within stators 9c and the piston core laminations 2e.

The transverse magnetic flux created in the stators 9c and piston core laminations 2f under the action of the switched coils 9a is also indicated in FIG. 4. The linear generator means 9 functions as a linear switched reluctance device, or as a linear switched flux device. Power is generated at the electrical output means 9e as the flux circuits, established in the stators 9c and induced in the piston core laminations 2f, are cut by the motion of the piston 2. This permits a highly efficient electrical generation means without the use of permanent magnets, which may demagnetise under the high temperature conditions within an internal combustion engine, and which might otherwise add significant cost to the engine due the use of costly rare earth metals.

Additionally, a control module 9d may be employed, comprising several different control means, as described below. The different control means are provided to achieve the desired rate of transfer of energy between the piston 2 and electrical output means 9e in order to deliver a maximum electrical output whilst satisfying the desired motion characteristics of the piston 2, including compression rate and ratio, expansion rate and ratio, and piston dwell time at top dead centre of each chamber 3, 4.

A valve control means may be used to control the intake valve 6c and the exhaust valve 7b. By controlling the closure of the exhaust valve 7b, the valve control means is able to control the start of the compression phase. In a similar way, the valve control means can also be used to control exhaust gas recirculation (EGR), intake charge and compression ratio.

A compression ratio control means that is appropriate to the type of electrical machine may also be employed. For example, in the case of a switched reluctance machine, compression ratio control is partially achieved by varying the phase, frequency and current applied to the switched coils 9a. This changes the rate at which induced transverse flux is cut by the motion of the piston 2, and therefore changes the force that is applied to the piston 2. Accordingly, the coils 9a may be used to control the kinetic energy of the piston 2, both at the point of exhaust valve 7b closure and during the subsequent deceleration of the piston 2.

A spark ignition timing control means may then be employed to respond to any residual cycle-to-cycle variability in the compression ratio to ensure that the adverse impact of this residual variability on engine emissions and efficiency are minimised, as follows. Generally, the expected compression ratio at the end of each compression phase is the target compression ratio plus an error that is related to system variability, such as the combustion event that occurred in the opposite combustion chamber 3, 4, and the control system characteristics. The spark ignition timing control means may adjust the timing of the spark ignition event in response to the measured speed and acceleration of the approaching piston 2 to optimize the combustion event o the expected compression ratio at the end of each compression phase.

The target compression ratio will normally be a constant depending on the fuel 5a that is used. However, a compression ratio error may be derived from a +/−20% variation of the combustion chamber height 3a. Hence if the target compression ratio is 12:1, the actual compression ratio may be in the range 10:1 to 15:1. Advancement or retardation of the spark ignition event by the spark ignition timing control means will therefore reduce the adverse emissions and efficiency impact of this error.

Additionally, a fuel injection control means may be employed to control the timing of the injection of fuel 5a so that it is injected into a combustion chamber 3, 4 immediately prior to the sliding port valve 6a closing to reduce hydrocarbon (NC) emissions during scavenging.

Furthermore, a temperature control means may be provided, including one or more temperature sensors positioned in proximity to the coils 9a, electronic devices and other elements sensitive to high temperatures, to control the flow of cooling air in the system via the compressor 6e in response to detected temperature changes. The temperature control means may be in communication with the valve control means to limit engine power output when sustained elevated temperature readings are detected to avoid engine damage.

Further sensors that may be employed by the control module 9d preferably include an exhaust gas (Lambda) sensor and an air flow sensor to determine the amount of fuel 5a to be injected into a chamber according to the quantity of air added, for a given fuel type. Accordingly, a fuel sensor may also be employed to determine the type of fuel being used.

FIG. 5a shows a perpendicular section through one of the stator elements 9c, showing the arrangement of coils 9a and stator 9c relative to each other. An alternative embodiment is shown in FIG. 5b, in which a single stator and coil are used to induce magnetic flux in two adjacent pistons 2. This configuration has a cost advantage compared to that shown in FIG. 5a due to the reduced number of coils 9a required.

FIG. 6 is a sectional view of the cylinder 1, which is preferably constructed from a material of low magnetic permeability, such as an aluminium alloy. The inner surface 1c of the cylinder 1 has a coating 1e of a hard, wear-resistant material such as nickel silicon-carbide, reaction bonded silicon nitride, chrome plating, or other metallic, ceramic or other chemical coating. On the outer surface 1d, an insulator coating 1f such as zirconium oxide or other sufficiently thermally insulating ceramic is applied. It will be apparent to a skilled person that the whole cylinder has an identical construction to this sectional view of the part of the cylinder close to the cylinder end 1g.

FIG. 7 shows the intake means 6 provided around the cylinder 1, the intake means 6 comprising apertures 6a, which are a corresponding size and align with the apertures 1a, 1b provided in the cylinder 1, and an air intake 6b. The apertures 6a in the intake means 6 are connected by a channel 6h in which an intake poppet valve 6c is seated. The channel 6h is of minimal volume, either having a short length, small cross sectional area or a combination of both, to minimise uncontrolled expansion losses within the channel 6h during the expansion phase.

The intake poppet valve 6c seals the channel 6h from an intake manifold 6f provided adjacent to the cylinder 1 as part of the air intake 6b. The intake poppet valve 6c is operated by a poppet valve actuator 6d, which may be an electrically operated solenoid means or other suitable electrical or mechanical means.

When the sliding port intake valve 6a and the intake poppet valve 6c are both open with respect to one of the first or second chambers 3, 4, the intake manifold 6f is in fluid communication with that chamber via the channel 6h. The intake means 6 is preferably provided with a recess 6g arranged to receive the intake poppet valve 6c when fully open to ensure that fluid can flow freely through the channel 6h.

The air intake 6b also includes an intake charge compressor 6e which may be operated electrically, mechanically, or under the action of pressure waves originating from the air intake 6b. The intake charge compressor 6e can also be operated under the action of pressure waves originating from an exhaust means 7 provided at each end of the cylinder 1, as described below. The intake charge compressor 6e may be a positive displacement device, centrifugal device, axial flow device, pressure wave device, or any suitable compression device. The intake charge compressor 6e elevates pressure in the intake manifold 6f such that when the air intake 6b is opened, the pressure in the intake manifold 6f is greater than the pressure in the chamber 3, 4 connected to the intake manifold 6f, thereby permitting a flow of intake charge fluid.

Fuel injection means 5 are also provided within the intake means 6, such as a solenoid injector or piezo-injector 5. Although a centrally positioned single fuel injector 5 may be adequate, there is preferably a fuel injector 5 provided either side of the intake poppet valve 6c and arranged proximate to the extremities of the sliding port valves 6a. The fuel injectors 5 are preferably recessed in the intake means 6 such that the piston 2 may pass over and past the sliding port intake valves 6a and air intake 6b without obstruction. The fuel injectors 5 are configured to inject fuel into the respective chambers 3, 4 through each of the sliding port intake valves 6a.

Lubrication means 10 are also provided preferably recessed within the intake means 6 and arranged such that the piston 2 may pass over and past the intake means 6 without obstruction, whereby the piston may be lubricated.

FIG. 8 shows the exhaust means 7 provided at each end of the cylinder 1. The exhaust means 7 comprises a cylinder head 7a removably attached, by screw means or similar, to the end of the cylinder 1. Within each cylinder head 7a is located an exhaust poppet valve 7b, coaxially aligned with the axis of the cylinder 1. The exhaust poppet valve 7b is operated by an exhaust poppet valve actuator 7c, which may be an electrically operated solenoid means or other electrical or mechanical means. Accordingly, when the intake poppet valve 6c and the exhaust poppet valve 7b within the first or second chamber 3, 4, are both closed, that chamber is effectively sealed and a working fluid contained therein may be compressed or allowed to expand.

The exhaust means 7 also includes an exhaust manifold channel 7d provided within the cylinder head, into which exhaust gases may flow, under the action of a pressure differential between the adjacent first or second chamber 3, 4 and the fluid within the exhaust manifold channel 7d when the exhaust poppet valve 7b is open. The flow of the exhaust gases can be better seen in the arrangement of cylinders illustrated in FIG. 20, which shows the direction of the exhaust gas flow o be substantially perpendicular to the axis of the cylinder 1.

Ignition means 8, such as a spark plug, are also provided at each end of the cylinder 1, the ignition means 8 being located within the cylinder head 7a and, preferably, recessed such that there is no obstruction of the piston 2 during the normal operating cycle of the engine.

The, preferably, coaxial arrangement of the exhaust poppet valve 7b with the axis of the cylinder 1 allows the exhaust poppet valve 7b diameter to be much larger relative to the diameter of the chambers 3, 4 than in a conventional internal combustion engine.

Each cylinder head 7a is constructed from a hard-wearing and good insulating material, such as ceramic, to minimise heat rejection and avoid the need for separate valve seat components.

FIG. 9 shows a time-displacement plot of an engine according to the present invention, illustrating the movement of the piston 2 over the course of a complete engine cycle. Although the operation of the engine is described here with reference to the first chamber 3, a skilled person will recognise that the operation and sequence of events of the second chamber 4 is exactly the same as the first chamber 3, but 180 degrees out of phase. In other words, the piston 2 reaches top dead centre in the first chamber 3 at the same time as it reaches bottom dead centre in the second chamber 4.

FIG. 9a is a table showing a number of different compression ratio control means that may be employed to control the compression ratio in response to changes in signals received from a number of different variables which can affect the compression ratio during an engine cycle. FIG. 9b is a flow chart corresponding to FIG. 9a and illustrates an exemplary compression ratio control sequence. The compression ratio control means may comprise part of the control module 9d, discussed earlier.

Both the table and flow chart illustrate the main variables which can affect the compression ratio at the different stages (A to F) of an engine cycle, such as the one illustrated in FIG. 9. These variables include: power demand from user, the fuel type being used, the compression ratio and knock status from the previous engine cycle, piston position, and the kinetic energy of a piston. The table and flow chart illustrate the different processes that take place to control the compression ratio and how the different variables affect these throughout an engine cycle and also the subsequent effect of each process, which can have an effect on more than one of the control processes throughout the engine cycle. It can be seen that in the last step of the sequence, once the expected compression ratio has been determined, optimum ignition timing is achieved by the spark ignition timing control means adjusting the timing of the spark event.

The events A to F, highlighted throughout the engine cycle, correspond to the events A to F illustrated in FIG. 10, which shows a typical pressure-volume plot for a combustion chamber 3, 4 over the course of the same engine cycle. The events featured in FIGS. 9 to 10 are referred to in the following discussion of FIGS. 11 to 19.

Considering now a complete engine cycle, at the start of the engine cycle, the first chamber 3 contains a compressed mixture composed primarily of pre-mixed fuel and air, with a minority proportion of residual exhaust gases retained from the previous cycle. It is well known that the presence of a controlled quantity of exhaust gases is advantageous for the efficient operation of the engine, since this can reduce or eliminate the need for intake charge throttling as a means of engine power modulation, which is a significant source of losses in conventional spark ignition engines. In addition, formation of nitrous oxide pollutant gases are reduced since peak combustion temperatures and pressures are lower than in an engine without exhaust gas retention. This is a consequence of the exhaust gas fraction not contributing to the combustion reaction, and due to the high heat capacity of carbon dioxide and water in the retained gases.

FIG. 11 shows the position of the piston relative to the cylinder 1, defining the geometry of the first chamber 3 at top dead centre (A). This is also around the point of initiation of the combustion phase AB. The distance between the top of the piston 2b and the end of the first chamber 3 is at least half the diameter of the first chamber 3, giving a lower surface area to volume ratio compared to combustion chambers in conventional internal combustion engines, and reducing the heat losses from the first chamber 3 during combustion. The ignition means 8 are recessed within the cylinder head 7a so that in the event that he piston 2 approaches top dead centre in an uncontrolled manner there is no possibility of contact between the ignition means 8 and the piston crown 2d. Instead, compression will continue until the motion of the piston 2 is arrested by the continuing build up of pressure due to approximately adiabatic compression in the first chamber 3. With reference to FIG. 10, the combustion expansion phase AB is initiated by an ignition event (A).

FIG. 12 shows the position of the piston 2 relative the linear generator means 9 mid-way through the expansion phase (AB and BC). The first chamber 3 expands as the piston 2 moves under the action of the pressure differential between the first chamber 3 and the second chamber 4. The pressure in the second chamber 4 at this point is approximately equivalent to the pressure in the intake manifold 6f. The expansion of the first chamber 3 is opposed by the action of the linear generator means 9, which may be modulated in order to achieve a desired expansion rate, to meet the engine performance, efficiency and emissions objectives.

FIG. 13 shows the position of the piston 2 at bottom dead centre relative to the first chamber 3. At the end of the expansion phase (C), the motion of the piston 2 is arrested under the action of the linear generator means 9 and the pressure differential between the first chamber 3 and the second chamber 4. The pressure in the second chamber 4 at this point is approximately equal to the high pressure in the first chamber 3 at its top dead centre position (A). Preferably, the expansion ratio is at least two times the compression ratio, wherein the compression ratio is in the range of 10:1 to 16:1. This gives an improved thermal efficiency compared to conventional internal combustion engines wherein the expansion ratio is similar to the compression ratio.

FIG. 14 shows the arrangement of the piston 2 and intake means 6 and the initial flow of intake gas at the time of bottom dead centre during the intake equalisation phase (CD). This arrangement can also be seen in FIG. 7. At this point, the sliding port intake valve 6a is open due to the piston 2 sliding through and past the apertures 1a, 1b provided along the inner wall 1c of the cylinder 1. The pressure in the first chamber 3 is lower than the pressure in the intake manifold 6f due to the over-expansion reducing fluid pressure in the first chamber 3 and due to the intake compressor 6e elevating the pressure in the intake manifold 6e. Around this time, the intake poppet valve 6c is opened by intake poppet valve actuator 6d allowing intake charge to enter the first chamber 3 within cylinder 1 whose pressure approaches equalisation with the pressure at the intake manifold 6f. A short time after the intake poppet valve 6c opens, the exhaust poppet valve 7b is also opened allowing exhaust gases to exit the first chamber 3 under the action of the pressure differential between the first chamber 3 and the exhaust manifold channel 7d, which remains close to ambient atmospheric pressure.

FIG. 15 shows the position of the piston 2 during the intake charge displacement scavenging phase (DE). Exhaust gas scavenging is achieved by the continuing displacement of exhaust gas in the first chamber 3 into the exhaust manifold channel 7d with fresh intake charge introduced at the piston end of the first chamber 3. Once the intended quantity of intake charge has been admitted to the first chamber 3, the intake poppet valve 6c is closed and the expulsion of exhaust gas continues by the movement of the piston 2, as shown in FIG. 17, explained below.

FIG. 16 shows the arrangement of the piston 2 and intake means 6 at the point of fuel injection (E). Fuel 5a is introduced directly onto the approaching piston crown 2d which has the effects of rapidly vaporising fuel, cooling the piston crown 2d and minimising the losses and emissions of unburned fuel as a wet film on the inner wall 1c of the cylinder 1, which might otherwise vaporise in the second chamber 4 during the expansion phase.

FIG. 17 shows the position of the piston 2 during lubrication (E), whereby a small quantity of lubricant is periodically introduced by the lubrication means 10 directly to the piston outer surface 2a as it passes the intake sliding port valve 6a. This arrangement minimises hydrocarbon emissions associated with lubricant wetting of the cylinder inner wall, and may also reduce the extent of dissolution of fuel in the cylinder inner wall oil film. Oil control ring features 2e are included in the piston crown 2d and/or bearing elements 2i to further reduce the extent of lubricant wall wetting in the first and second chambers 3, 4.

FIG. 18 shows the position of the piston 2 during the piston displacement scavenging phase EF. The intake poppet valve 6c is closed and the expulsion of exhaust gas continues by the movement of the piston 2. The piston 2 at this time is moving towards the exhaust means 7 and reducing the volume of the first chamber 3 due to the combustion event in the second chamber 4.

As a result of the relatively larger diameter of the exhaust poppet valve, as discussed above, the limiting area in the exhaust flow past the valve stem may approach 40% of the cylinder bore section area, resulting in low exhaust back pressure losses during both the intake charge displacement scavenging phase (DE) and piston displacement scavenging phase (EF).

FIG. 19 shows a longitudinal section of the position of the piston 2 relative to the cylinder 1 mid-way through the compression phase (FA). When a sufficient exhaust gas expulsion has been achieved, such that the proportion of exhaust gas in the fluid in the first chamber 3 is close to the intended level, the exhaust poppet valve 7b is closed and the compression phase (FA) begins. Compression continues at a varying rate as the piston 2 accelerates and decelerates under the action of the pressure differential between the first chamber 3 and the second chamber 4. The pressure in the second chamber 4 is at this point falling during the expansion phases (AB and BC) and by the action of the linear generator means 9. The linear generator force may be modulated in order to achieve the desired compression rate to meet the engine performance, efficiency and emissions objectives. The compression rate in the first chamber 3 is substantially equal to and opposite the expansion rate in chamber 4.

FIG. 20, FIG. 21 and FIG. 22 show the construction of an exemplary engine arrangement comprising four free-piston engines according to the present invention, configured to operate in cycles that are synchronised to create a fully balanced engine. In this configuration, the overall length of the engine generating 50 kw with a thermal efficiency of around 50% is approximately 1400 mm.

FIG. 20, in particular, shows how the cylinder 1 may be located coaxially within a cylinder housing 11, providing structural support and cooling means 12. The cylinder housing 11 may be slightly shorter than the cylinder 1 and the cylinder heads 7a may be attached, by screw fixings or any other suitable means, to the cylinder housing 11 to maintain compression between each cylinder head 7a and the surface of each cylinder end 1d. The cylinder housing 11 is attached, by screw fixings or any other suitable means, to a structural housing 13 which provides the basis for mechanical attachment of the engine to a vehicle or other device drawing electrical power from the electrical output means 9e. An enclosure 14 provides a physical enclosure for the engine, manifolds and control systems. Interfaces are provided across the enclosure 14 for intake and exhaust flows, admission of fuel and lubricant, rejection of heat, output of electrical power and input of electrical power for start-up and control.

FIG. 22 shows an end view of an arrangement in which a cylinder head 7a houses four engines according to the present invention, whereby exhaust gases exit an engine's combustion chamber 3, 4 via the exhaust poppet valve 7b and flow substantially perpendicular to the axes of the cylinders 1.

1. A piston for an engine generator, comprising alternating laminated core elements and non-magnetising spacer elements arranged along a piston shaft and secured such that contact is maintained between neighbouring elements, wherein the length of the piston is at least five times its maximum diameter.

2. The piston of claim 1, further comprising a piston crown provided at each extremity of the piston.

3. The piston of claim 2, wherein the piston crown is ceramic.

4. The piston of claim wherein the piston crown is concave.

5. The piston of claim 1, further comprising one or more bearing rings spaced along the piston shaft.

6. The piston of claim 5, wherein the one or more bearing rings is ceramic or carbon.

7. The piston of claim 1, wherein the diameter of the one or more bearing rings is greater than the diameter of the core and spacing elements.

8. The piston of claim 1, wherein the core elements and spacer elements are formed as annular rings having the same diameters.

9. The piston of claim 1, wherein the spacer elements are aluminium alloy.

10. The piston of claim 1, wherein the spacer elements have voids formed within them.

11. The piston of claim 1 wherein the piston crown incorporates oil control and sealing ring features.

12. The piston of claim 1, wherein the one or more bearings incorporates oil control and sealing ring features.
